(19) United States
(12) Patent Application Publication
(10) Pub. No.: US 2010/0206330 A1
(43) Pub. Date: Aug. 19, 2010

(54) Apparatus and Method for Cleaning Wine Barrels

(76) Inventor: Bob Flook, Santa Rosa, CA (US)

Correspondence Address: Richard C. O'Hare, Esq, 135 Keller St., Suite D, Petaluma, CA, 94952, US

(21) Appl. No.: 11/922,947

(22) PCT Filed: Jun. 29, 2006
(86) PCT No.: PCT/US2006/025604

§ 371 Date: Mar. 29, 2010

Related U.S. Application Data
(60) Provisional application No. 60/694,692, filed on Jun. 29, 2005.

(51) Int. Cl. B08B 9/00

(52) U.S. Cl. 134/7; 134/140

(57) ABSTRACT

An apparatus and method, as shown in FIG. 1, for cleaning barrels (3) by blasting with cryogenic abrasive media through a nozzle (2). The nozzle (2) translates along rail (4) while barrel (3) rotates to completely clean barrel (3). The apparatus provides automated means for blasting barrels (3).

### CROSS REFERENCE

This application claims the benefit of U.S. Provisional Patent Application Ser. No. 60/694,692 filed Jun. 29, 2005.

### TECHNICAL FIELD

This invention relates to an apparatus and method for cleaning barrels. More particularly, the invention relates to an apparatus and method for cleaning wooden wine barrels using a cryogenic abrasive media, such as dry ice.

### BACKGROUND OF THE INVENTION

Wooden barrels, particularly oak barrels, have been used for centuries to store and age wine. Quality barrels are essential to the winemaking process as the wood in the barrels imparts flavor to the stored wine. These barrels add significantly to the cost of making wine with some barrels costing in excess of US $1500.00. If the barrels are to be reused, the interior surfaces must be satisfactorily cleaned. It is a long-standing problem to satisfactorily clean the interior surfaces of wine barrels so that they may be refilled and reused in the process of aging wine.

Several methods for cleaning the interior of wine barrels have been suggested and used in the prior art. One method disclosed and used in the prior art is the simple mechanical stripping of the interior surface of the barrel using a plane or sander. This method is both time-consuming and cumbersome and has the additional disadvantage of generating significant waste.

Chemical cleaning of barrels has also been disclosed and used in the prior art. Chemical cleaning also has several disadvantages, including the generation of large waste streams. More importantly, however, the chemical cleaning of barrels may impart undesirable flavors to future wine products.

Another method for cleaning wine barrels is disclosed in U.S. Pat. No. 6,368,554. This method utilizes intense pulsed optical radiation, in essence a laser, to clean the interior of barrels.

Periodic maintenance of wine barrels using the method and apparatus of this invention provides significant advantages over the cleaning methods of the prior art, including:

(1) Extending the life of a barrel before it becomes “neutral”;

(2) Increasing the surface area of the interior of the barrel;

(3) Eliminating the need for re-toasting the barrel;

(4) Providing no off-flavors;

(5) Substantially reducing the time required to effectively clean a barrel;

(6) Reducing or eliminating solid and liquid waste streams; and,

(7) Killing mold growth.

Cryogenic abrasive media, such as dry-ice pellets, have been used for removing contaminant buildup from a variety of media. Indeed, mobile blasting units are commercially available and are known in the art to provide an effective means of removing contaminant deposits from equipment or other surfaces. Cryogenic abrasive media are particularly suited for removing a variety of deposits which are difficult to remove by other means because the cryogenic abrasive media cools the deposits and renders them brittle. Indeed, dry ice pellets have a temperature no greater than −78 degrees Celsius. Furthermore, the energy absorbed by the cryogenic abrasive media when striking a surface causes the media to sublime into a gas. Since the cryogenic abrasive media sublimes to a gas at atmospheric temperature and pressure, the gas dissipates into the atmosphere, leaving no residue on the cleaned surface or any solid or liquid waste to be disposed of. Moreover, cryogenic abrasive blasting has been shown to kill mold and mold spores.

### DISCLOSURE OF THE INVENTION

The instant invention provides an efficient and effective means for cleaning barrels. Barrels can be easily rolled onto the device and, within minutes, effectively cleaned with cryogenic abrasive media. Little or no waste products are generated in the cleaning process and no residue from the cleaning media is left in the barrel.

In its most simple form, the invention comprises a cryogenic blasting device and a means for translating an outlet of the cryogenic blasting device over the interior surface of a barrel while maintaining an optimum distance, angle and speed to effectuate cleaning of the barrel.

Accordingly, an object of the instant invention is to provide a device and method for cleaning the interior of barrels and more particularly wooden wine barrels in a quick and efficient manner.

Another object of the instant invention is to provide a device and method for cleaning the interior of wine barrels which does not leave traces of chemicals that may adversely affect the taste of future wine products.

A further object of the instant invention is to provide a device and method for cleaning the interior of barrels that does not create excessive solid waste.

An even further object of the instant invention is to provide a device and method for cleaning the interior of barrels that does not create a contaminated aqueous waste stream.

The apparatus of this invention comprises a cryogenic blasting device. Such devices are known in the art to accelerate solid cryogenic particles, such as solid carbon dioxide (dry ice) pellets, to a high velocity. One such device is the Aero 30 Cold Jet dry ice blasting device. The Aero 30 Cold Jet has been found to be ideal for the invention when its delivery rotor is retooled to deliver between 4 and 5 lbs. of dry ice per minute. Nevertheless, one of ordinary skill in the art would understand that other dry ice blasting devices are suitable for use with this invention. The cryogenic blasting devices known in the art further comprise a nozzle with an outlet where the cryogenic particles are released to the atmosphere at high velocity. In the present invention, the nozzle is attached to at least one linear actuator which can move the outlet in relation to a barrel stand.

The apparatus of this invention further comprises a barrel stand which is capable of supporting and rotating a barrel. The linear actuator is mounted to the barrel stand by way of an actuator carriage which permits lateral movement of the linear actuator with respect to the axis of the barrel. In a preferred embodiment of the invention, lateral movement of the actuator carriage is affected by a motorized lead screw.

In a preferred embodiment of the invention, the barrel stand comprises four adjustable support wheels positioned so as to hold a barrel substantially horizontally on the barrel stand. The support wheels are preferably mounted on two shafts which can freely rotate in relation to the rest of the barrel stand with at least one of the two shafts connected to a drive means to effectuate rotation of the barrel. In a preferred embodiment the drive means is an electric motor, however, one of ordinary skill in the art would understand that many other means can be used to effectuate rotation of the barrel including gas powered motors and manual devices.

In a most preferred embodiment of the invention, the two shafts are positioned 16 inches apart and the two wheels on each shaft are positioned 19 inches apart. In this most preferred embodiment, the drive means rotates one of the shafts so that a speed of sixty inches per minute is achieved at the circumference of the support wheels.

The movement of the linear actuator and the actuator carriage is controlled by a process loop controller in a preferred embodiment. By controlling the movement of the linear actuator and the actuator carriage, the process loop controller translates the outlet of the nozzle over substantially the entire interior surface of the barrel while maintaining the optimum distance from the interior barrel surface.

The apparatus of this invention may also comprise second and third linear actuators which are capable of translating the outlet in directions substantially perpendicular to the first linear actuator. In a preferred embodiment, these second and third linear actuators are capable of translating the outlet a distance of at least 40 inches.

In a still further preferred embodiment of the invention, the nozzle is capable of rotating 90 degrees so that it can point in one direction of the movement of the first actuator and also in a direction which is 90 degrees to that direction. In a separate preferred embodiment, the nozzle is adjustably mounted to the actuator so that it may be positioned pointing in one direction of the movement of the first actuator and adjusted to point in a direction 90 degrees to that direction.

### BRIEF DESCRIPTION OF THE DRAWINGS

The appended drawings depict a preferred embodiment of the apparatus for cleaning wine barrels according to this invention in which:

FIG. 1 is a brief frontal view of the apparatus;

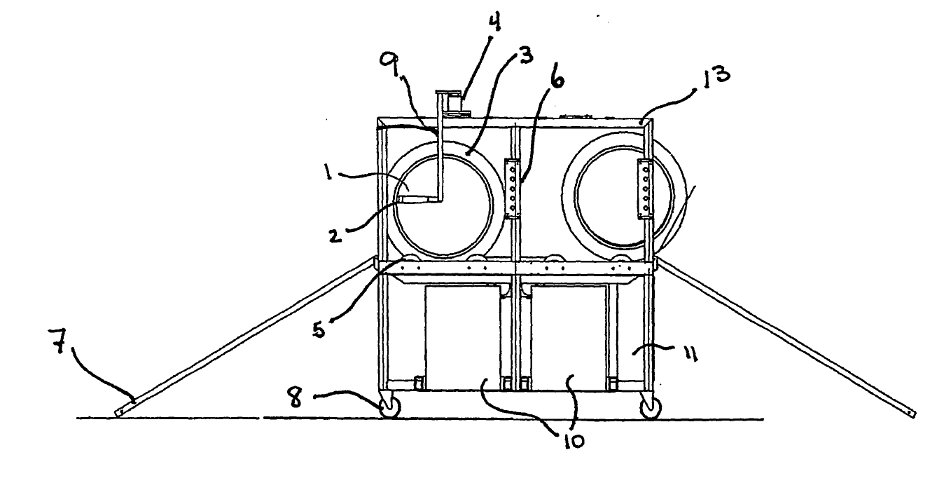

FIG. 2 is a brief view of the apparatus of this invention;

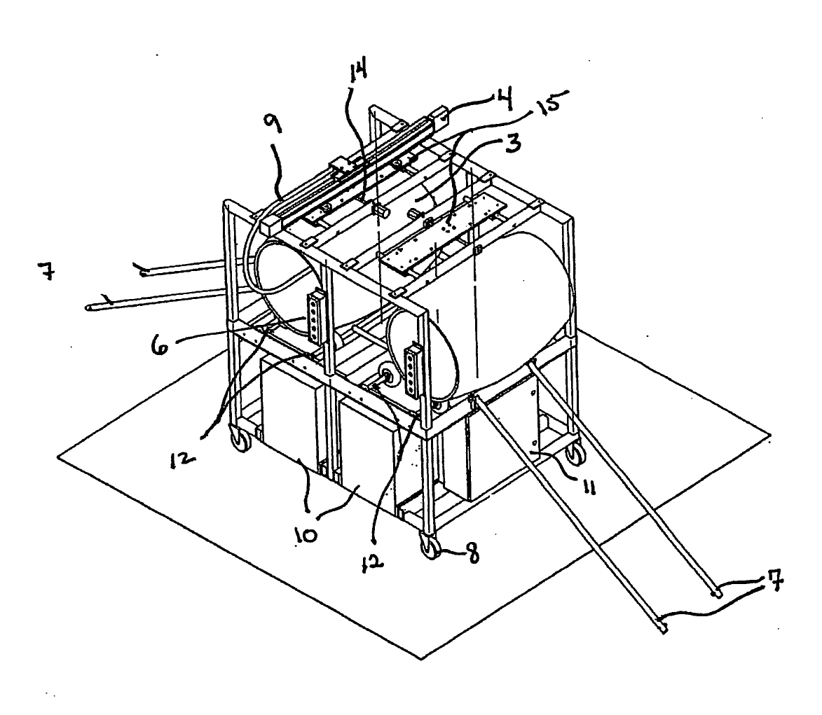

FIG. 3 is a brief overhead view of the apparatus; and,

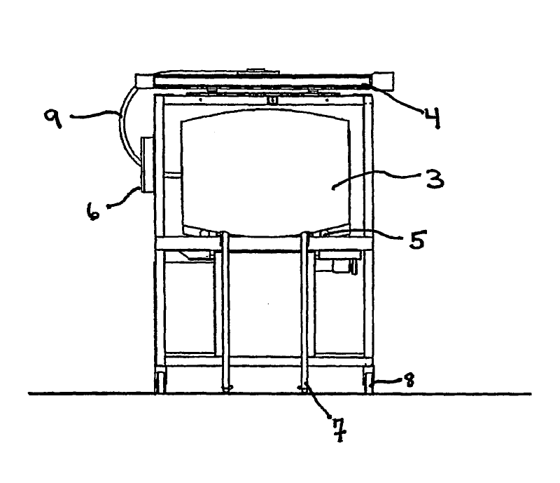

FIG. 4 is a brief side view of the apparatus.

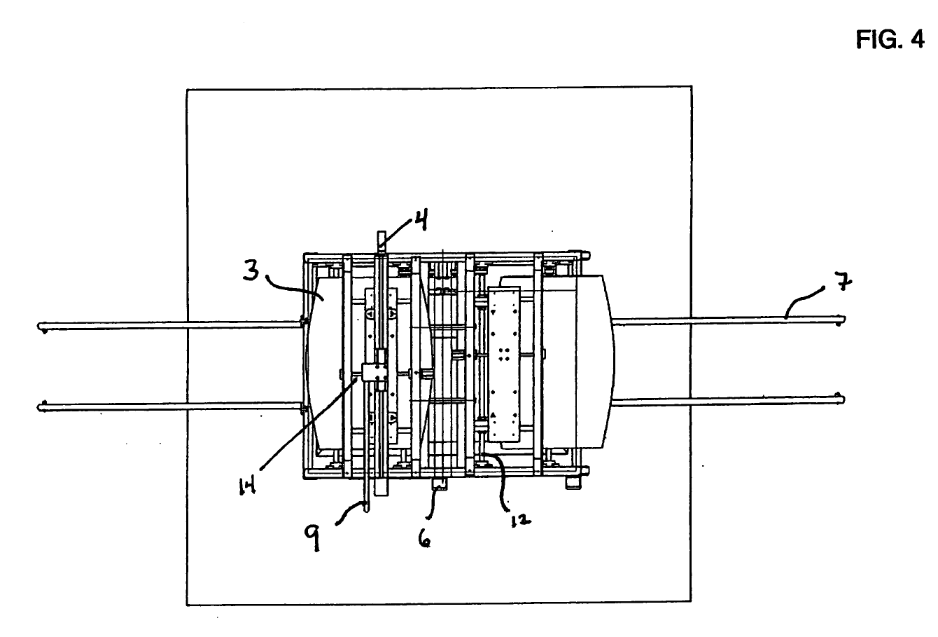

### DETAILED DESCRIPTION OF THE BEST MODE

A most preferred embodiment this invention will be described below with reference to the drawings. This most preferred embodiment, depicted in the drawings, actually comprises two cleaning stations. The cleaning station pictured on the left in the drawings is fully equipped for automated cleaning pursuant to this invention, while the cleaning station depicted on the right in the drawings is not fully equipped, but may nonetheless be used for manual blasting of barrels.

A nozzle (1) for directing dry ice particles from a cryogenic blasting device (10) is shown. Dry ice particles from the cryogenic blasting device are transported to the nozzle through a transport tube (9) and exit the nozzle at high pressure through an aperture (2). The nozzle (1) is connected to a linear actuator (4) by the transport tube or by any other substantially rigid connector. The linear actuator operates to translate the nozzle substantially linearly from the front of the barrel stand (13) towards the rear of the barrel stand and back to the front. The linear actuator is mounted to an actuator carriage on the barrel stand. The actuator carriage is supported on at least two linear bearing shafts permitting lateral motion of the actuator with respect to the axis of the barrel (3). A motor controlled lead screw (14) provides for the lateral motion.

Support wheels (5) are provided for supporting the barrel (3) on the barrel stand (13). The support wheels (5) are mounted on shafts (12) which can freely rotate in relation to the rest of the barrel stand (13). At least one of the shafts per cleaning stations is connected to a drive means.

Ramp bars (7) are reversibly affixed to the barrel stand (13) to facilitate positioning the barrel (3) on the barrel stand (13). In this preferred embodiment the ramp bars can be removed to facilitate storage of the apparatus. A user interface (6) is provided to permit manual operation of the device and to start and stop automated operation. A process loop controller (11) provides for automated control of the apparatus. The entire barrel stand is mounted on wheels (8) to facilitate its movement.

Through experimentation the inventor has determined optimum settings and conditions for cleaning wine barrels. These settings and conditions are provided to provide the best mode for the practice of this invention; however, the invention is not limited by these conditions.

In a preferred embodiment of the invention, the method for cleaning wine barrels comprises, removing one end of a wine barrel, laying the wine barrel horizontally on a barrel stand which rotates the barrel at a preferred rate of 7-8 revolutions per minute. The outlet of a cryogenic blasting device is then translated linearly within the barrel, from the top of the barrel to the bottom, at a rate of between 10 and 15 inches per minute while a pre-selected distance of between 1 and 4 inches, and most preferably 2 inches, is maintained from the barrel's interior surface.

The inventor has also determined that for general cleaning, the cryogenic abrasive particles should be extruded from the cryogenic blasting device at a pressure of between 75 lbs. per square inch and 100 lbs. per square inch, and most preferably at 80 lbs. per square inch. When it is desired that some wood be removed from the barrel wall during the cleaning process, the blasting device should be set to extrude particles at a pressure of between 90 lbs. per square inch and 110 lbs. per square inch, and most preferably at 100 lbs. per square inch.

The inventor has also determined through experimentation that a grounding system is needed to carry static charges away from the barrels during cleaning. In this most preferred embodiment the grounding system comprises braided tin-copper straps which are ½ to ¾ inches wide that are attached to barrel stand 1⅛ inches apart, center to center. These braided tin copper straps hang down from the barrel stand to make contact with the barrel and preferably metal barrel hoops that are found on some barrels. The straps carry static charges away from the barrel to the barrel stand. The barrel stand in turn is grounded to a true ground to dissipate static charge.

I claim:

1. An apparatus for cleaning the interior surface of a barrel comprising a barrel stand for supporting a barrel, a drive means for rotating the barrel along its horizontal axis, a nozzle with a aperture for directing accelerated cryogenic abrasive particles at said interior surface, and a means for translating said outlet over substantially the entire interior surface of said barrel.

2. The apparatus of claim 1 further comprising a grounding system to carry away static charge from said barrel.

3. The apparatus of claim 2 wherein the means for translating said outlet over substantially the entire interior surface of said barrel comprises a linear actuator.

4. The apparatus of claim 3 wherein the means for rotating the barrel along its horizontal axis comprises an electric motor.

5. The apparatus of claim 2, wherein the nozzle is disposed at an angle of 90 degrees relative to the interior surface of the barrel.

6. A method for cleaning the interior surface of a barrel comprising the steps of:
removing the head of the barrel;
placing the barrel on a barrel stand;
rotating the barrel in relation to the barrel stand; and,
directing cryogenic abrasive particles at the interior wall of the barrel.

7. The method of claim 6 wherein the barrel is rotated at a rate of between 6 and 9 revolutions per minute.

8. The method of claim 6 wherein the cryogenic abrasive particles are extruded through an outlet of a nozzle and wherein the distance between said outlet and said interior surface is maintained at between one and three inches.

9. The method of claim 8 wherein a process loop controller maintains said outlet at a distance of between one and three inches from said interior surface.
